(19) United States
(12) Patent Application Publication
(10) Pub. No.: US 2011/0007611 A1
(43) Pub. Date: Jan. 13, 2011

(54) Chronograph timepiece

(76) Inventors: Kazuo Kato, Chiba-shi (JP); Akira Takakura, Chiba-shi (JP); Kenji Ogasawara, Chiba-shi (JP); Saburo Manaka, Chiba-shi (JP); Kazumi Sakumoto, Chiba-shi (JP); Hiroshi Shimizu, Chiba-shi (JP); Tomohiro Ihashi, Chiba-shi (JP); Keishi Honmura, Chiba-shi (JP); Takanori Hasegawa, Chiba-shi (JP); Kosuke Yamamoto, Chiba-shi (JP); Eriko Noguchi, Chiba-shi (JP)

Correspondence Address: BRUCE L. ADAMS, ESQ;ADAMS & WILKS, SUITE 1231, 17 BATTERY PLACE, NEW YORK, NY, 10004, US

(21) Appl. No.: 12/803,564

(22) Filed: Jun. 29, 2010

(30) Foreign Application Priority Data
Jul. 6, 2009 (JP) 2009-160136

(51) Int. Cl. G04F 8/00

(52) U.S. Cl. 368/113

(57) ABSTRACT

In response to an instruction to start time measurement given by a start/stop button, an in-phase drive control unit outputs an in-phase control signal of a predetermined time width to a drive pulse generation circuit such that a stepping motor is driven, instead of by a first drive pulse, by an initial drive pulse of a longer drive time than the drive pulse. The drive pulse generation circuit rotates the stepping motor by a motor drive signal including a plurality of in-phase main drive pulses. The stepping motor is rotated by one of the main drive pulses included by the motor drive signal to rotate the chronograph hands.

### BACKGROUND OF THE INVENTION

1. Field of the Invention

The present invention relates to a chronograph timepiece having a time indicating function and a time measuring function.

2. Background Art

Conventionally, there has been developed a chronograph timepiece in which a plurality of drive motors are mounted in order to individually drive a plurality of indicator hands and which is endowed with a time information indicating function as the basic function and, further, a chronograph function to perform time measurement, wherein the driving of the indicator hands is electrically effected by the drive motors, and the zero-restoring of chronograph hands is effected by a mechanical mechanism such as hearts (See, for example, JP-A-2005-3493 for the chronograph timepiece, and JP-A-2003-185765 for the motors).

In a chronograph timepiece of a construction in which, as in the case of the chronograph timepiece disclosed in JP-A-2005-3493, the chronograph hands are electrically drive-controlled and mechanically zero-restoring-controlled, in the reset state, for example, the heart of an arbor (shaft) with a chronograph hand is mechanically maintained in the zero-restored state by a hammer.

Thus, when, in the above chronograph timepiece, an instruction to start chronograph operation is given by depressing a start button, it is necessary for a motor rotation drive signal for starting chronograph hand movement to be output (hand movement control start) in response to the depression of the start button after a lever related to zero-restoring is rotated or the like to thereby displace the hammer, thereby permitting rotation of the chronograph arbor integral with the heart (i.e., releasing zero-restoring control).

Actually, however, the requisite time for the releasing of the zero-restoring control is not strictly fixed; in particular, it is a mechanical control and involves variation in the related components; further, if, in order to minimize the cost, an attempt is made to make the structure as simple as possible, the variation is also likely to increase, so that variation between the individual products is not always small.

On the other hand, if the releasing of the zero-restoring control has not been completed at the point in time when a motor rotation drive signal is output to start the hand movement control, an accurate chronograph operation cannot be conducted.

To avoid this, it has conventionally been necessary to redesign the mechanical system, taking the variation into account and in accordance with the time measurement cycle of the chronograph timepiece (which is, for example, 1/100 sec), such that the delay in the releasing of the zero-restoring control is made reliably shorter than the time measurement cycle. Here, safety in terms of variation is to be attained, there is, in many cases, nothing for it but to prepare a mechanical system which is more expensive than the one actually required.

It is true that JP-A-2005-3493 makes a proposal regarding the necessity for the matching in timing, which is a problem inherent in a system in which an electrical drive control and a mechanical control for stopping or the like are combined with each other. More specifically, JP-A-2005-3493 proposes a technique, etc. in which the mechanical structure is modified to control the timing for the starting of the zero-restoring control or the like in order to avoid a situation in which the mechanical control for stopping or the like is started although a rotation drive signal for the motor is still being output. However, this modification proposed in JP-A-2005-3493 neither discloses nor suggests a technique leading to the solution of the above problem involved at the time of starting chronograph operation in a chronograph timepiece in the zero-restored (reset) state.

### SUMMARY OF THE INVENTION

It is an aspect of the present invention to provide a chronograph timepiece of the type in which a chronograph hand is electrically drive-controlled and mechanically zero-restoring-controlled, wherein it is possible to prevent a motor for driving the chronograph hand from being electrically driven before the releasing of the mechanical setting with respect to the rotation of the chronograph hands to thereby hinder accurate hand movement.

According to the present invention, there is provided a chronograph timepiece comprising: an operating means giving at least an instruction to start time measurement; a setting mechanism mechanically setting a chronograph hand to a zero-restoring position in a reset state; a releasing means releasing the setting of the chronograph hand by the setting mechanism in response to the instruction to start time measurement given by the operating means; a stepping motor driving the chronograph hand; and a control means effecting control such that the stepping motor drives the chronograph hand at a predetermined cycle in response to the instruction to start time measurement given by the operating means, wherein the control means drives the stepping motor with, instead of a first drive pulse, an initial drive pulse of a longer drive time than the drive pulse in response to the instruction to start time measurement given by the operating means.

According to the present invention, there is provided a chronograph timepiece of the type in which a chronograph hand is electrically drive-controlled and mechanically zero-restoring-controlled, wherein it is possible to prevent a motor for driving the chronograph hand from being electrically driven before the canceling of mechanical setting with respect to the rotation of the chronograph hands to thereby hinder accurate hand movement.

### BRIEF DESCRIPTION OF THE DRAWINGS

FIG. 1 is a block diagram showing a chronograph timepiece according to an embodiment of the present invention;

FIGS. 2A and 2B are schematic plan views of the mechanical construction of a chronograph mechanism of a chronograph timepiece according to an embodiment of the present invention;

FIG. 3 is a plan view of the external appearance of a chronograph timepiece according to an embodiment of the present invention.

FIG. 4 is a timing chart for a chronograph timepiece according to an embodiment of the present invention; and

FIG. 5 is a flowchart according to an embodiment of the present invention.

FIG. 6 is a timing chart for a chronograph timepiece according to an embodiment of the present invention.

### DESCRIPTION OF THE PREFERRED EMBODIMENTS

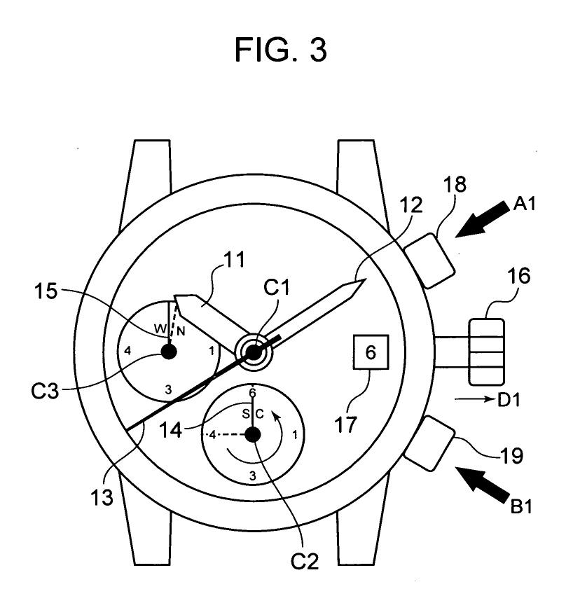

As shown in FIG. 3, a chronograph timepiece 1 according to an embodiment of the present invention is in the form of a wristwatch, and is equipped with time hands (an hour hand 11, a minute hand 12, and a second hand 13) rotated around a center axis C1 and serving to indicate the current time, and chronograph hands (a chronograph second hand 14 rotated around a center axis C2, and a chronograph minute hand 15 rotated around a center axis C3).

For example, by turning a winding stem 16 in a state in which it has been drawn out by two steps in a direction D1, it is possible to rotate the time hands 11 through 13, and, by turning the winding stem 16 in a state in which it has been drawn out by one step in the direction D1, it is possible to change a date 17 of a date indicator displayed through a window. The operation related to the normal time display of the chronograph timepiece 1 is the same as that of an ordinary electronic timepiece, and is well known by those skilled in the art, so that, in the following, a description of the structure, function, and operation related to the normal hand movement will be omitted.

In the chronograph timepiece 1, the chronograph hands 14, 15 are electrically drive-controlled by a stepping motor, and zero-restoring-controlled by a mechanical construction.

In the chronograph timepiece 1, by depressing a start/stop button 18 in a direction A1, there is given an instruction to start or stop chronograph operation by the chronograph timepiece 1. More specifically, the starting/stopping of the chronograph operation implies the staring/stopping of the movement of the chronograph hands 14, 15; as described below, in this connection, the operation of an electrical drive system and the retention of electrical positional information on the chronograph hands are effected. In some cases, however, there is no need to effect the retention of electrical positional information on the chronograph hands. The start/stop button 18 at least constitutes an operating means giving an instruction to start time measurement.

Further, in the chronograph timepiece 1, by depressing a reset button 19 in a direction B1, there is given an instruction to reset the chronograph operation by the chronograph timepiece 1, i.e., to restore to an initial state (zero-restoring). More specifically, the resetting of the chronograph operation implies forcible restoring (zero-restoring) of the chronograph hands 14, 15 to initial positions (time indicating positions), the setting of the hand movement of the chronograph hands 14, 15, and the resetting of the electrical positional information on the chronograph hands.

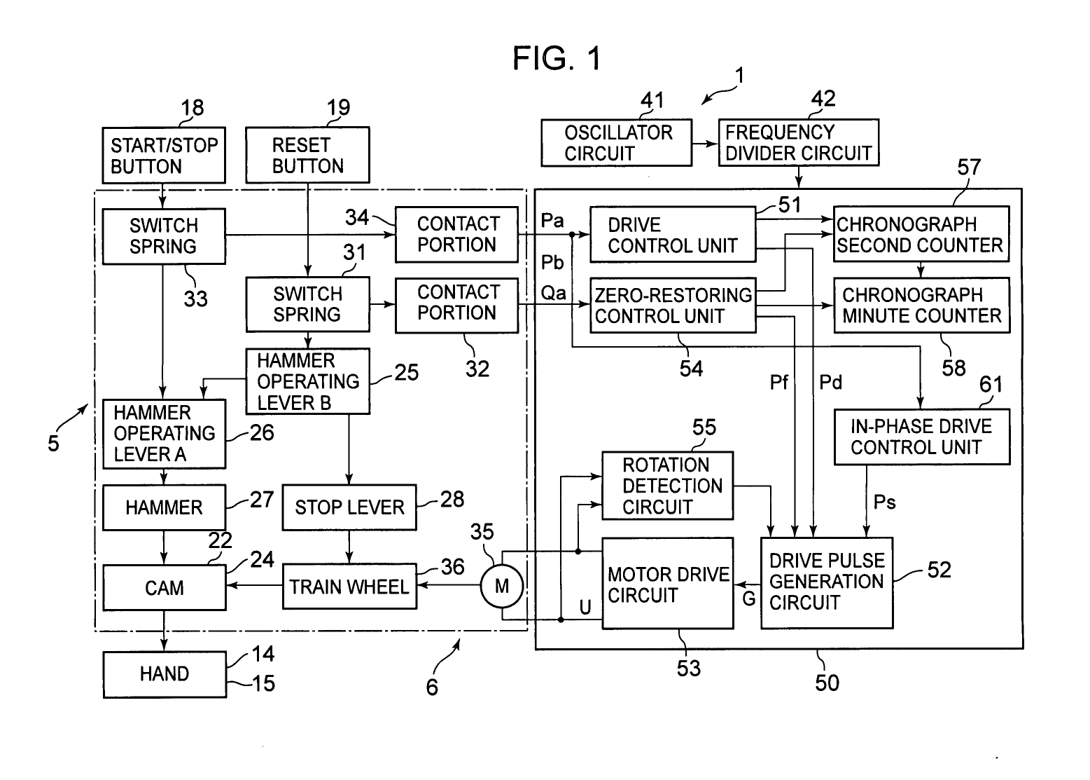

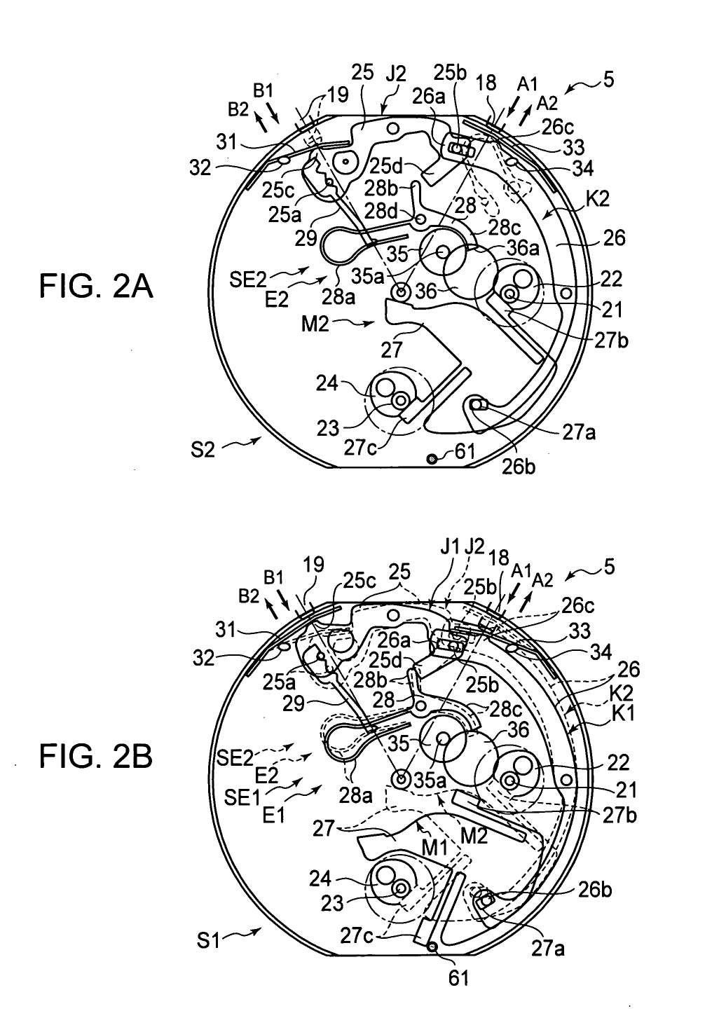

First, a mechanical structure 5 and an operation related to the starting, hand movement, and zero-restoring of the chronograph timepiece 1 will be described mainly with reference to FIGS. 2A and 2B. The mechanical structure 5 related to the starting, hand movement, and zero-restoring of the chronograph timepiece 1 is also briefly shown in the left-hand portion of the block diagram of FIG. 1.

Apart from a motor (not shown) for normal hand movement (time hand movement), the chronograph timepiece 1 is equipped with a chronograph hand movement motor 35; when rotated, the chronograph hand movement motor 35 moves the chronograph hands 14, 15 via a chronograph hand movement train wheel 36.

The normal hand movement motor and the chronograph hand movement motor 35 are stepping motors of a well-known construction for use in timepieces (See, for example, JP-A-2003-185765). The stepping motor includes a stator having a rotor accommodating hole and a positioning portion for determining a rotor stop position, a rotor arranged in the rotor accommodating hole, and a drive coil; in the stepping motor, the rotor is rotated by generation of magnetic flux in the stator by being supplied with alternating signals (drive pulses) whose polarity differ alternately to the drive coil, and the rotor is stopped at a position corresponding to the positioning portion. Each time driving is alternately effected with the drive pulses of different polarities, the rotor is rotated by a predetermined angle (e.g., 180 degrees), and even if the driving is continuously effected with a plurality of in-phase drive pulses, when the rotation is effected with the first drive pulse, no rotation is effected by the second in-phase drive pulses onward.

The chronograph timepiece 1 is equipped with a chronograph second cam 22 mounted to a chronograph second arbor 21 with the chronograph second hand 14, and a chronograph minute cam 24 mounted to a chronograph minute arbor 23 with the chronograph minute hand 15.

Further, the chronograph timepiece 1 is equipped with a hammer operating first lever (hereinafter also referred to as the “hammer operating lever B”) 25, a hammer operating second lever (hereinafter also referred to as the “hammer operating lever A”) 26, a hammer 27, and a stop lever 28.

The chronograph second cam 22, the chronograph minute cam 24, and the hammer 27 constitute a setting mechanism, and the hammer operating second lever 26 and the hammer 27 constitute a releasing means. The hammer operating second lever 26 and the hammer 27 also constitute a lever means.

The hammer operating first lever 25 is rotatable between a reference position J1 (indicated by the solid line in FIG. 2B) and a zero-restoring position J2 (indicated by the solid line in FIG. 2A and the dotted line in FIG. 2B); positioning is effected thereon at the reference position J1 or the zero-restoring position J2 through engagement of a positioning pin 25a with a spring-like positioning member 29 equipped with an engagement groove. An elongated hole 26a of the hammer operating second lever 26 is engaged with a pin 25b of the hammer operating first lever 25. When the hammer operating first lever 25 is moved from the reference position J1 to the zero-restoring position J2 and position setting is effected thereon, the hammer operating second lever 26 is moved from a reference position K1 (indicated by the solid line in FIG. 2B) to a zero-restoring position K2 (indicated by the solid line in FIG. 2A and by the dotted line in FIG. 2B).

On the other hand, when the hammer operating second lever 26 is moved from the zero-restoring position K2 to the reference position K1 and position setting is effected thereon, the hammer operating first lever 25 is moved from the zero-restoring position J2 to the reference position J1 and positioning is effected thereon.

An elongated hole 27a of the hammer 27 is engaged with a pin 26b of the hammer operating second lever 26, and positioning is effected thereon at a reference position Ml (indicated by the solid line in FIG. 2B) or a zero-restoring position M2 (indicated by the solid line in FIG. 2A and the dotted line in portion FIG. 2B) in accordance with the position setting of the hammer operating second lever 26 at the reference position K1 or the zero-restoring position K2.

When the hammer 27 is set at the zero-restoring position M2, a second hammer portion 27b of the hammer 27 strikes the chronograph second cam 22 to zero-restore the chronograph second hand 14 to the initial position, and a minute hammer portion 27c thereof strikes the chronograph minute cam 24 to zero-restore the chronograph minute hand 15 to the initial position.

The stop lever 28 is equipped with a spring portion 28a, an engagement arm portion 28b, and a lock arm portion 28c, and is rotatable around a pin 28d between a correction control position or setting position E2 at the time of zero-restoring (indicated by the solid line in FIG. 2A and the dotted line in FIG. 2B) and a correction control releasing position or setting releasing position E1 (indicated by the solid line in FIG. 2B). In a state SE2 in which the stop lever 28 is at the setting position E2, the lock arm portion 28c of the stop lever 28 is engaged with one wheel 36a of a chronograph hand movement train wheel 36 connected to a rotor cogwheel 35a of the chronograph hand movement motor 35 to effect the setting of the rotation of the train wheel 36, and, in a state SE1 in which the stop lever 28 is at the setting releasing position E1, it is separated from the wheel 36a of the train wheel 36 to permit the rotation of the rotor cogwheel 35a of the motor 35 and the train wheel 36.

When the hammer operating first lever 25 is rotated and displaced from the zero-restoring position J2 to the reference position J1, the engagement arm portion 28b of the stop lever 28, whose spring portion 28a is under a biasing force toward the setting position E2, engaged with the arm portion 25d of the hammer operating first lever 25, and the stop lever 28 is rotated and displaced from the setting position E2 at the time of zero-restoring to the setting releasing position E1. On the other hand, when the hammer operating first lever 25 is moved from the reference position J1 to the zero-restoring position J2, the engagement of the arm portion 25d of the hammer operating first lever 25 with the engagement arm portion 28b is released, so that the stop lever 28 is restored from the setting releasing position E1 to the setting position E2 by the spring force of the spring portion 28a thereof.

When the start/stop button 18 is depressed in the direction A1, with the chronograph timepiece 1 being in the zero-restored (reset) state S2 shown in FIG. 2A, a protrusion 26c of the hammer operating second lever 26 is pressed in the direction A1 and the lever is displaced from the position K2 to the position K1, and the hammer operating first lever 25 is displaced from the position J2 to the position J1, with the hammer 27 being displaced from the position M2 to the position M1. As a result, the rotation setting (zero-restoring control) of the hearts 22, 24 and the chronograph hands 14, 15 by the hammer portions 27b, 27c is released. Further, in response to the rotation of the hammer operating first lever 25 from the position J2 to the position J1, the stop lever 28 whose arm portion 28b is engaged with the arm portion 25d of the hammer operating first lever 25 is rotated from the setting position E2 to the setting releasing position El, and the lock arm portion 28c of the stop lever 28 is separated from the chronograph train wheel 36 to release the rotation setting (stop control) of the train wheel 36. As a result, the mechanical control mechanism 5 is restored to the state S1, and the chronograph hands 14, 15 become rotatable.

On the other hand, when the reset button 19 is depressed in the direction B1, with the chronograph timepiece 1 being in the start state or hand movement state S1 shown in FIG. 2B, the protrusion 25c of the hammer operating first lever 25 is pressed in the direction B1, and the hammer operating first lever 25 is displaced from the position J1 to the position J2. When the hammer operating first lever 25 is displaced from the position J1 to the position J2, the hammer operating second lever 26 engaged with the lever 25 is moved from the position K1 to the position K2 on the one hand, and the hammer 27 engaged with the lever 26 moves from the position M1 to the position M2, with the second hammer 27b and the minute hammer 27c striking the second heart 22 and the minute heart 24 to zero-restore the chronograph secondhand 14 and the chronograph minute hand 15; on the other hand, the lock of the arm portion 25d with respect to the stop lever 28 is released, and the stop lever 28 is rotated from the position E1 to the position E2, with the arm portion 28c thereof being engaged with the chronograph train wheel 36 to effect setting on the train wheel 36.

Regarding the chronograph timepiece 1, as far as the mechanical structure 5 shown in FIGS. 2A and 2B is concerned, the electrical aspect thereof is as follows.

When the start/stop button 18 is depressed in the direction A1, with the chronograph timepiece 1 being in the reset state S2 shown in FIG. 2A, the start/stop button 18 presses the start/stop switch spring 33 exerting a biasing force in the direction A2 in the vicinity of the depth end thereof to close a contact portion 34, generating a start signal Pa (FIG. 1) via the contact portion 34. When the start/stop button 18 is depressed in the direction A1, with the chronograph timepiece 1 being in the start state S1 shown in FIG. 2B, the start/stop button 18 presses the start/stop switch spring 33 to close the contact portion 34, generating a stop signal Pb (FIG. 1) via the contact portion 34.

On the other hand, when the reset button 19 is depressed in the direction S1, with the chronograph timepiece 1 being in the start state (or the stop state) S1 shown in FIG. 2B, the reset button 19 presses a reset switch spring 31 exerting a biasing force in the direction B2 in the vicinity of the depth end thereof to close a contact portion 32, generating a reset signal Qa (FIG. 1) via the contact portion 32.

Of the above operations, in the following, a more detailed description will be given mainly of the starting and progress of the start operation when the start/stop button 18 is depressed in the direction A1 in the zero-restoring state S2 of FIG. 2A.

That is, as the start/stop button 18 is depressed in the direction A1, there is output, on the one hand, an electrical drive start signal Pa via the switch contact 34, thereby rotating the motor 35; on the other hand, the mechanical zero-restoring control state is released through rotation of the hammer 27 as a result of the rotation of the hammer operating second lever 26, and, at the same time, the lock (stop control state) of the train wheel 36 is released through the rotation of the stop lever 28 as a result of the rotation of the hammer operating second lever 26 and of the hammer operating first lever 25, and the hand movement is mechanically permitted (i.e., the mechanical setting is released).

Here, for the chronograph timepiece 1 to properly operate and for the time measurement to be accurately conducted, it is necessary for the motor 35 to be rotated after the completion of the releasing of the mechanical setting. In the chronograph timepiece 1, electrical driving is reliably effected after the completion of the releasing of the mechanical setting while avoiding complication of the structure and an increase in cost entailed. In the following, mainly this point will be described in detail.

Next, the outline of an electrical drive mechanism 6 of the chronograph timepiece 1 will be described mainly with reference to the block diagram of FIG. 1 while referring to the mechanical structure 5 of FIG. 2.

The rotation of the chronograph hand movement motor 35 of the chronograph timepiece 1 is controlled by a drive control integrated circuit 50 for the chronograph hand movement motor 35 drive-controlled based on clock pulses provided via an oscillator circuit 41 and a frequency divider circuit 42.

The motor drive control integrated circuit 50 includes a basic drive control unit 51, a drive pulse generation circuit 52, a motor drive circuit 53, a zero-restoring control unit 54, a rotation detection circuit 55, and an in-phase drive control unit 61. Here, the driving means for the chronograph hand movement motor 35 consists of the motor drive circuit 53, and the drive control means for the chronograph hand movement motor 35 has the basic drive control unit 51, the drive pulse generation circuit 52, the zero-restoring control unit 54, the rotation detection circuit 55, and the in-phase drive control unit 61. The basic drive control unit 51, the drive pulse generation circuit 52, the motor drive circuit 53, and the in-phase drive control unit 61 constitute a control means. Further, the in-phase drive control unit 61 constitutes an in-phase signal drive control means.

Further, the motor drive control integrated circuit 50 has a chronograph second counter 57 counting chronograph seconds and retaining the chronograph second information, and a chronograph minute counter 58 counting chronograph minutes and retaining the chronograph minute information. Further, there may be provided a chronograph hour counter counting chronograph hours and retaining the chronograph hour information.

The basic drive control unit 51 receives a start signal or operation signal Pa provided via the contact portion 34 in response to the depression of the start/stop button 18 when the chronograph timepiece 1 is in the zero-restored (reset) state S2. The in-phase drive control unit 61 also receives the start signal or operation signal Pa. Upon receiving the signal Pa, the in-phase drive control unit 61 outputs to the drive pulse generation circuit 52 an in-phase control signal Ps1 for driving the motor 35 with initial drive pulses of a longer drive time than ordinary drive pulses (which, in this embodiment, are pulses formed by a plurality of in-phase drive pulses) when the chronograph hand drive timing has been arrived at. The time width of the in-phase control signal Ps1 is larger than that of the main drive pulses (e.g., the length of a plurality of main drive pulses) but shorter than the chronograph hand drive cycle T; it is a rectangular wave signal kept at high level for a predetermined period of time only.

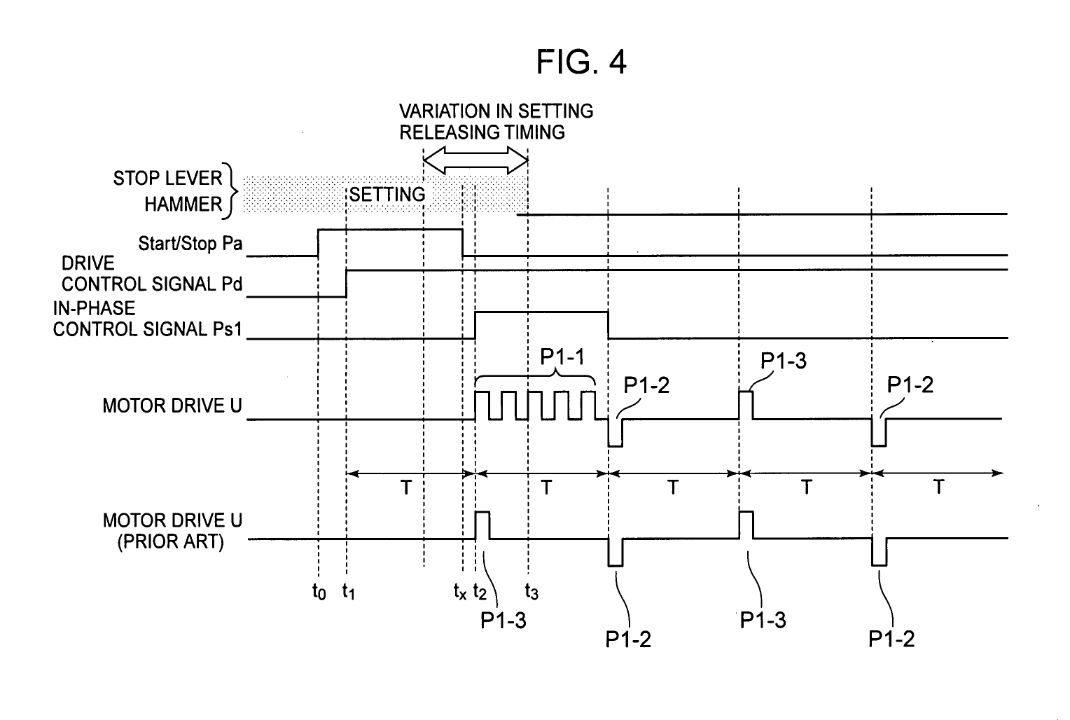

Upon receiving the start signal or operation signal Pa, the basic drive control unit 51 issues a drive control signal Pd after a short period of time for preventing chattering. In the following, unless otherwise specified in relation to FIG. 4, etc. referred to below, it will be assumed that the point in time when the start signal or operation signal Pa is received and the point in time when the drive control signal Pd is transmitted are substantially identical with each other. The drive control signal Pd is a signal which is maintained at high level while the chronograph operation is being conducted.

Further, upon receiving a stop signal Pb provided via the contact portion 34 in response to the depression of the start/stop button 18 when the chronograph timepiece 1 is in the start state S1 (or when the transmission of the start signal or operation signal Pa from the contact portion 34 is stopped), the basic drive control unit 51 stops the transmission of the drive control signal Pd.

The drive control signal Pd from the basic drive control unit 51 is also supplied to the chronograph second counter 57; while the drive control signal Pd is maintained at high level, the chronograph second counter 57 receives clock pulses supplied from the frequency divider circuit 42 to count chronograph seconds, and, using a point in time t1 when the chronograph time measurement is started based on the drive control signal Pd as the start point, emits a chronograph timing pulse Ph for each cycle T from that point in time onward. The cycle (chronograph hand drive cycle) T of the pulse Ph corresponds to the time measurement accuracy of the chronograph timepiece 1; for example, it is 1/100 sec (that is, 10 ms).

Upon receiving the drive control signal Pd and the in-phase control signal Ps1, the drive pulse generation circuit 52 supplies a plurality of in-phase ordinary chronograph hand movement main pulses (initial drive pulses) G to the motor drive circuit 53 instead of the ordinary chronograph hand movement main drive pulse while the in-phase control signal Ps1 is at high level. The motor drive circuit 53 imparts a plurality of in-phase motor drive pulses U corresponding to the initial drive pulses G to the chronograph hand movement motor 35 to drive the motor 35. When it is continuously driven by the plurality of in-phase main drive pulses, the motor 35 does not rotate after being rotated by one of the drive pulses even if driven by the subsequent in-phase main drive pulses. From this onward, the motor 35 is alternately driven by ordinary main drive pulses of different polarities to rotate by a predetermined angle at one time.

On the other hand, when the basic drive control unit 51 receives the stop signal Pb, the drive control unit 51 stops the emission of the drive control signal Pd (If so desired, it is also possible to impart a drive stop signal Pf); and the emission of the drive pulses G from the drive pulse generation circuit 52 is stopped, and the emission of the motor drive pulses U by the motor drive circuit 53 is stopped; the rotation of the chronograph hand movement motor 35 is stopped, and the rotation of the rotor or output shaft of the motor 35 is stopped to thereby stop the hand movement of the chronograph hands 14, 15 via the chronograph hand movement train wheel 36.

When the switch spring 31 is pushed down through depression of the reset button 19, and the contact portion 32 is closed, the reset signal Qa is imparted to the zero-restoring control unit 54. Upon receiving the reset signal Qa from the contact portion 32, the zero-restoring control unit 54 imparts the drive stop signal Pf to the drive pulse generation circuit 52. As a result, the drive pulse generation circuit 52 stops the generation of the drive pulses G, and stops the emission of the motor drive pulses U by the motor drive circuit 53. Thus, the rotation of the chronograph hand movement motor 35 is stopped, and the hand movement of the chronograph hands 14, 15 is stopped. Upon receiving the reset signal Qa, the zero-restoring control unit 54 resets the contents of the chronograph second counter 57 and of the chronograph minute counter 58 to zero.

Next, regarding the chronograph timepiece 1 of FIG. 1, mainly the control operation of the in-phase drive control unit 61 will be concretely described with reference to the time chart of FIG. 4.

Suppose the start/stop button 18 is depressed in the direction A1 at a point in time t0, with the chronograph timepiece 1 being in the reset state S2. As the start/stop button 18 is depressed, the contact portion 34 is closed, and the start signal Pa is output via the contact portion 34. The start signal Pa is continued until a point in time tx up to which the closing of the contact portion 34 as a result of the depression of the start/stop button 18 is continued.

When the start signal Pa is imparted to the basic drive control unit 51, the basic drive control unit 51 starts chronograph time measurement operation at a point in time t1 after a short period of time necessary for avoiding the influence of chattering. Further, simultaneously with the reception of the start signal Pa, the basic drive control unit 51 outputs the drive control signal Pd to the drive pulse generation circuit 52.

On the other hand, at a point in time t2 when the motor 35 is rotated for the first time after the reception of the start signal Pa (the point in time after the chronograph hand drive cycle T from the point in time t1 when the chronograph time measurement operation is started), the in-phase drive control unit 61 outputs the in-phase control signal Ps1 to the drive pulse generation circuit 52. The pulse width maintaining the in-phase control signal Ps1 at high level is set to be slightly shorter than the chronograph hand drive cycle T.

While the in-phase control signal Ps1 is maintained at high level, the drive pulse generation circuit 52 generates initial drive pulses G including a plurality of in-phase ordinary main drive pulses P1-3, and generates motor drive pulses U corresponding to the initial drive pulses G in the motor drive circuit 53. Like the initial drive pulses G, the motor drive pulses U are drive pulses P1-1 including a plurality of (five in the example of FIG. 4) in-phase ordinary main drive pulses P1-3.

That is, in the case of the conventional drive control in which control with the in-phase control signal Ps1 is not effected, one ordinary main drive pulse P1-3 is issued as the motor drive pulse U (prior art) as shown at the bottom of FIG. 4 at the point in time t2 after the cycle T from the point in time t1 when the chronograph time measurement is started, whereas, in the chronograph timepiece 1 of this embodiment, drive pulses P1-1 consisting of a plurality of in-phase main drive pulses P1-3 are issued as the motor drive pulses U during a predetermined period of time from the point in time t2. The motor 35 is driven by the motor drive pulses U.

As shown at the top of FIG. 4, until a point in time after the elapse of a predetermined period of time from the point in time t0 when the start/stop button 18 is depressed and the contact 34 is closed, causing the start signal Pa to attain high level, the hammer 27 effects setting on the second heart 22 and the minute heart 24, and the stop lever 28 effects setting on the train wheel 36. Thus, if driving is effected with the conventional motor drive pulses U, the chronograph hands cannot be moved. However, as in this embodiment, by effecting driving with the drive pulses P1-1, of the main drive pulses P1-3 included therein, the main drive pulses P1-3 generated after the releasing of the setting by the hammer 27 and the stop lever 28 can be used to drive the motor 35. The main drive pulses P1-3 included by the drive pulses P1-1 are in phase, so that after the motor 35 is driven by one of the main drive pulses P1-3, the motor 35 does not rotate if driven with the main drive pulses P1-3 included thereafter, and the chronograph hands 14, 15 are not rotated excessively, making it possible to effect reliable hand movement.

After the completion of the in-phase control signal Ps1, the motor 35 is hand-movement-driven as usual by the main drive pulses P1-2, P1-3 whose polarity changes alternately. As a result, an accurate movement of the chronograph hands 14, 15 is realized.

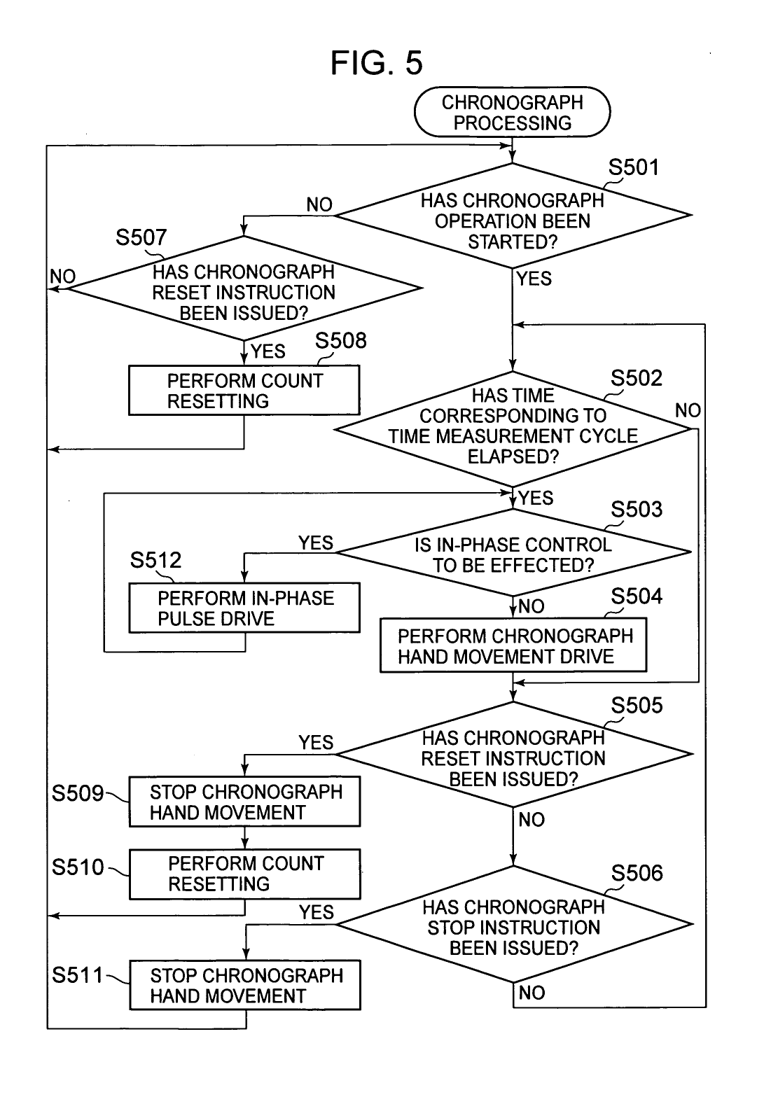

Next, the operation of the chronograph timepiece 1 constructed as described above will be described mainly with reference to the flowchart of FIG. 5 while referring to FIGS. 1 through 4. This flowchart shows mainly the operation of the basic drive control unit 51 and the in-phase drive control unit 61 of the integrated circuit 50 of the chronograph timepiece. 1 as a program processing flow corresponding to the operation.

In the chronograph timepiece 1, in the first processing step S501, it is checked whether an instruction to start the chronograph operation has been issued or not. This start checking step S501 corresponds to the checking as to whether or not the switch spring 33 has been displaced in the direction A1 through depression of the start/stop button 18 at the point in time t0 to close the contact portion 34 to effect contact, causing the operation signal or start signal Pa to be imparted to the basic drive control unit 51 of the integrated circuit 50.

In the case in which no start signal Pa has been output, it is checked in step S507 whether or not an instruction to reset (zero-restore) has been issued or not. This reset checking step S507 corresponds to the checking as to whether or not the switch spring 31 has been displaced in the direction B1 through depression in the direction B1 of the reset (zero-restoring) button 19 to close the contact portion 32 to thereby cause the reset signal Qa to be imparted to the zero-restoring control unit 54 of the integrated circuit 50. In the case in which no reset signal Qa has been issued, the procedure returns to the first processing step S501. In the case in which the reset signal Qa has been issued, there is performed in step S508 a count resetting processing to restore the contents of the chronograph second counter 57 and of the chronograph minute counter 58 to zero, and then the procedure returns to the first processing step S501.

In the start checking step S501, when the instruction to start chronograph operation (start signal Pa) is confirmed, it is checked in step S502 whether or not a period of time corresponding to the time measurement cycle of the chronograph operation (i.e., the chronograph hand drive cycle) T (which, in this example, is, for instance, 1/100 sec, i.e., 10 ms) has elapsed. When the time measurement cycle T has been attained, the procedure advances to step S503. This corresponds to the fact that the timing pulse Ph is issued when, in the chronograph second counter 57, the time from the point in time t1 for starting chronograph operation onward is measured, and a time (point in time t2) corresponding to the time measurement cycle T has been attained.

In the case in which the period of time T has elapsed, when the in-phase drive control unit 61 receives the start signal Pa in the point in time t2 to perform in-phase control (in-phase drive control using a plurality of main drive pulses) (step S503), an in-phase control signal Ps1 of a predetermined time width is output the drive pulse generation circuit 52 (step S512). While the in-phase control signal is being received, the drive pulse generation circuit 52 imparts, instead of ordinary drive pulses for chronograph drive, initial drive pulses G consisting of a plurality of in-phase ordinary chronograph hand movement drive pulses to the motor drive circuit 53. The motor drive circuit 53 imparts to the chronograph hand movement motor 35 motor drive pulses U (P1-1) consisting of a plurality of in-phase main drive pulses P1-3 corresponding to the initial drive pulses G to thereby rotate the motor 35. When continuously driven by the plurality of in-phase drive pulses P1-3, the motor 35 does not rotate even if driven by the subsequent in-phase drive pulses P1-3 after it has been rotated by one of the drive pulses P1-3. As a result, the chronograph hands 14, 15 are reliably hand-movement-driven.

In the case in which the in-phase drive control unit 61 does not receive the start signal Pa and does not perform in-phase control in step S503 (In this case, the drive by the motor drive pulses P1-1 has already been completed), the drive pulse generation circuit 52 outputs, in response to the drive control signal Pd from the basic drive control circuit 51, the drive pulse G so as to drive the motor 35 by a main drive pulse of a different polarity from the main drive pulse with which the previous drive has been effected. In response to the drive pulse G, the motor drive circuit 53 rotates the motor 35 by a main drive pulse U (P1-2 or P1-3) of a polarity opposite to that of the main drive pulse with which the previous drive has been effected (step S504). The rotation detection circuit 55 detects whether or not the motor 35 has been rotated; when the rotation detection circuit 55 detects that the motor 35 has not been rotated by the driving with the main drive pulse, the drive pulse generation circuit 52 controls the motor drive circuit 53 so as to effect forcible rotation drive with a correction drive pulse of a large pulse width. This makes it possible to reliably rotate the motor 35 with the motor drive circuit 53.

When each hand movement drive is effected in step S504, it is checked in step S505 whether or not a chronograph reset instruction (reset signal Qa) has been issued. The judgment processing in step S505 itself is the same as that in step S507.

In the case in which no reset instruction has been issued, it is checked in step S506 whether or not a chronograph stop instruction (stop signal Pb) has been issued.

In the case in which no stop instruction has been issued, the procedure returns to step S502 to repeat the above processing.

When, in step S502, the time measurement cycle has not been attained, step S502 is usually repeatedly returned to via steps S505, S506 until the time measurement cycle is attained.

Here, after the start step S501, until a stop instruction (stop signal Pb) is issued in step S506, the chronograph hands 14, 15 are moved in steps S502, S503, and S504, and, thereafter, the procedures of steps S506, S507 are repeated with the answer being “No,” whereby there is performed the normal chronograph hand movement to move the chronograph hands 14, 15.

On the other hand, when it is detected by the drive control unit 51 in step S506 that the stop instruction has been issued (emission of the stop signal Pb from the contact portion 34), the procedure advances to step S511; in step S511, there is performed a stopping processing to stop the movement of the chronograph hands 14, 15 (the stopping of transmission of the control signal Pd to the drive pulse generation circuit 52 or the transmission of the drive stop signal Pf); thereafter, the procedure returns to step S501.

When it is detected in step S505 that a reset instruction has been issued (the transmission of the reset signal Qa from the contact portion 32), the procedure of the zero-restoring control unit 54 advances to a chronograph hand movement stopping step S509, which is similar to step S511 in that the drive stop signal Pf is imparted to the drive pulse generation circuit 52, and there is performed in the hand movement stopping step S509 a stopping processing to stop the movement of the chronograph hands 14, 15. Next, the zero-restoring control unit 54 performs a count reset processing to restore the contents of the chronograph second counter 57 and of the chronograph minute counter 58 to zero in a count resetting step S510, which is similar to step S508, and then the procedure returns to the first processing step S501.

As described above, there is provided a chronograph timepiece of the type in which the chronograph hands are electrically drive-controlled and mechanically zero-restoring-controlled, wherein it is possible to prevent the chronograph hand drive motor from being electrically driven before the releasing of the mechanical setting with respect to the rotation of the chronograph hands to thereby hinder accurate hand movement. Further, until the cam setting releasing is completed, in-phase drive pulses are output at a cycle shorter than the chronograph hand movement cycle T, whereby the hand movement is effected with the drive pulses after the releasing of the setting to prevent non-rotation of the motor, so that it is possible to perform a reliable hand movement. Further, the hand movement drive pulses and the setting of the mechanism do not overlap each other, so that it is possible to prevent a delay in hand movement, and to reduce the restrictions in terms of mechanism, thus increasing the degree of freedom in designing. Further, since the hand movement drive pulses immediately after the chronograph operation start and the setting of the mechanism do not overlap each other, there is no need for a mechanism to control the maximum time until the hammer and the stop lever are reliably released.

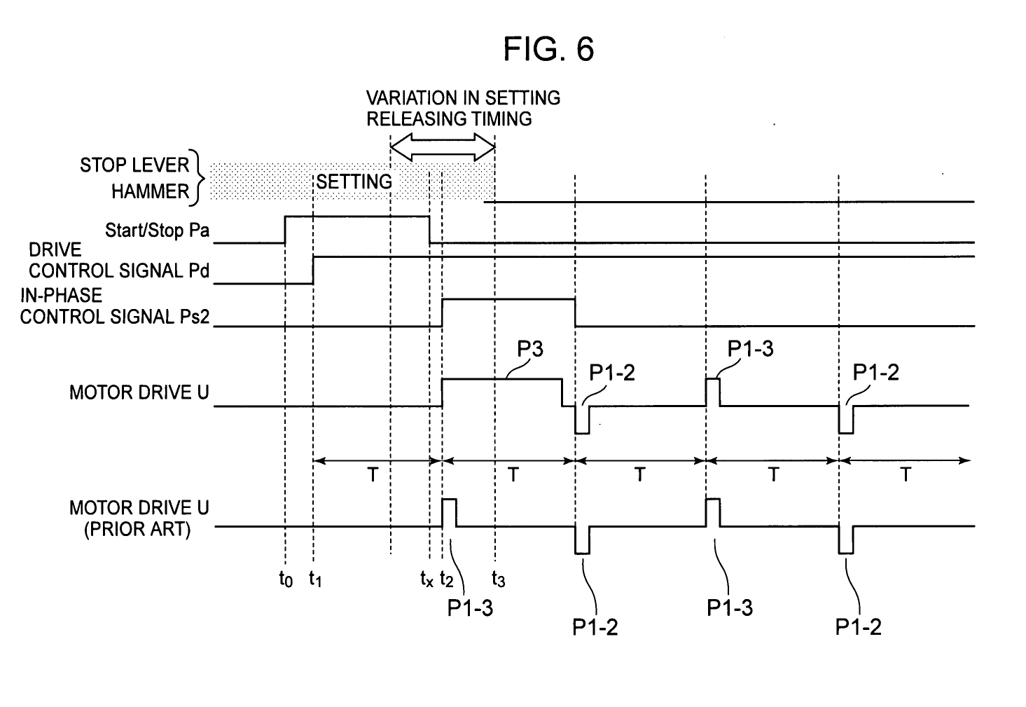

FIG. 6 is a timing chart for a chronograph timepiece according to another embodiment of the present invention; the portions that are the same as those of FIG. 4 are indicated by the same reference numerals. The block diagram of FIG. 1, the mechanical construction view of FIG. 2, the external view of FIG. 3, and the flowchart of FIG. 5 are also applicable to the other embodiment.

While the above embodiment employs the in-phase control signal Ps1 including a plurality of in-phase drive pulses in order to perform in-phase control, the other embodiment employs, as shown in FIG. 6, an in-phase control signal Ps2 of a pulse width continuing for a predetermined period of time. The in-phase control signal Ps2 is a rectangular wave signal which is longer than the main drive pulse and shorter than the chronograph hand drive cycle T and which attains high level only for a predetermined period of time.

When performing a Pa in-phase control in response to a start signal, the in-phase drive control unit 61 outputs the in-phase control signal Ps2 of a predetermined time width longer than the main drive pulse to the drive pulse generation circuit 52, and the motor drive circuit 53 rotates the motor 35 with a drive pulse U (P3) of a time width corresponding to the in-phase control signal Ps2. This makes it possible to reliably rotate the motor 35. Otherwise, this embodiment is of the same operation as the above embodiment.

Also in this embodiment, as in the above embodiment, it is possible to prevent the chronograph hand drive motor from being electrically driven before the releasing of the mechanical setting with respect to the rotation of the chronograph hands to thereby hinder accurate hand movement.

As the drive pulse U (P3) of a time width corresponding to the in-phase control signal Ps2, a correction drive pulse may be utilized.

Further, while in the chronograph of the above embodiments the chronograph second hand is arranged on the 6 o'clock side, and the chronograph minute hand is arranged on the 9 o'clock side, the present invention is also applicable to a center chronograph using the hand 13 as the chronograph second hand.

The present invention is applicable to various types of chronograph timepiece in which the driving of the time hands and the chronograph hands is electrically effected by a motor and in which, in the reset state, setting is effected by a mechanical mechanism so that the chronograph hands may not move, with the driving of the chronograph hands being effected after the releasing of the setting by the mechanical mechanism.

What is claimed is:

1. A chronograph timepiece comprising: an operating means giving at least an instruction to start time measurement;
a setting mechanism mechanically setting a chronograph hand to a zero-restoring position in a reset state; a releasing means releasing the setting of the chronograph hand by the setting mechanism in response to the instruction to start time measurement given by the operating means; a stepping motor driving the chronograph hand; and a control means effecting control such that the stepping motor drives the chronograph hand at a predetermined cycle in response to the instruction to start time measurement given by the operating means,
wherein the control means drives the stepping motor with, instead of a first drive pulse, an initial drive pulse of a longer drive time than the drive pulse in response to the instruction to start time measurement given by the operating means.

2. A chronograph timepiece according to claim 1, wherein the initial drive pulse has a plurality of in-phase main drive pulses.

3. A chronograph timepiece according to claim 1, wherein the initial drive pulse is a drive pulse continuing for a longer period of time than the first main drive pulse.

4. A chronograph timepiece according to claim 3, wherein the drive pulse is a correction drive pulse longer than the main drive pulse.

5. A chronograph timepiece according to claim 1, wherein the initial drive pulse is a drive pulse within the drive cycle.

6. A chronograph timepiece according to claim 2, wherein the initial drive pulse is a drive pulse within the drive cycle.

7. A chronograph timepiece according to claim 3, wherein the initial drive pulse is a drive pulse within the drive cycle.

8. A chronograph timepiece according to claim 4, wherein the initial drive pulse is a drive pulse within the drive cycle.
